(19) United States
(12) Patent Application Publication
(10) Pub. No.: US 2003/0112204 A1
(43) Pub. Date: Jun. 19, 2003

(54) Cascading of multi-or bi-stable liquid crystal display elements in large self-organizing scalable low frame rate display boards

(75) Inventor: Gunnar B. Pettersen, Barkaker (NO)

Correspondence Address: BANNER & WITCOFF, LTD., TEN SOUTH WACKER DRIVE, SUITE 3000, CHICAGO, IL, 60606, US

(73) Assignee: PolyDisplay ASA, Sandefjord (NO)

(21) Appl. No.: 10/294,148

(22) Filed: Nov. 14, 2002

Related U.S. Application Data
(60) Provisional application No. 60/331,325, filed on Nov. 14, 2001.

(30) Foreign Application Priority Data
Nov. 14, 2001 (NO) NO 20015571

(51) Int. Cl. G09G 5/00; G09G 3/36

(52) U.S. Cl. 345/1.1; 345/87

(57) ABSTRACT

The invention concerns a display board, a method of driving and a method for building low frame rate scalable display boards from special liquid crystal display devices. A liquid crystal display board comprising a number N of liquid crystal sub-displays arranged in i rows and j columns such that N=i×J,

comprises a number of sections of sub-displays, each section of sub-displays comprises exactly one controller connected to a master module, the sections further comprises a number of column modules having a column driver chain and a number of row modules having a row driver chain, and

the row and column driver chains is designed to provide a write signal to the corresponding row/column of the associated sub-display. The liquid crystal sub-displays preferably comprise a bi- or multi-stable liquid crystal type, preferably a smectic A liquid crystal.

This application claims priority to provisional U.S. Application Ser. No. 60/331,325, which was filed on Nov. 14, 2001, the entire disclosure of which is hereby incorporated by reference.

### FIELD OF INVENTION

The invention concerns a display board, a method of driving and a method for building low frame rate scalable display boards from special liquid crystal display devices.

### BACKGROUND OF THE INVENTION

Liquid crystal display devices have become important as displays because of features like small size and lightweight and modest power consumption.

Liquid crystal displays able to show more than a few hundred information elements, are usually based on a co-ordinate matrix addressing system in order to keep the number of connections and electrical driver channels at a manageable level. Such devices comprise a group of scanning electrodes and a group of signal electrodes arranged in a matrix, and a liquid crystal compound is filled between the electrode groups to form a plurality of picture elements to display the information. These display devices employ a time-sharing driving method, which comprises the steps of selectively applying address signals sequentially and cyclically to each electrode in the group of scanning electrodes, and parallel effecting selective application of predetermined information signals to the group of signal electrodes in synchronism with address signals. These display devices and their driving methods, often have drawbacks.

Most liquid crystal compositions being used in display devices are still some sort of twisted nematic type. These liquid crystal molecules will when properly aligned and anchored in one end, under the application of a suitable electric field, change their twist angle and the way they influence polarized light. When display devices based on a co-ordinate matrix addressing system are implemented using liquid crystals of this type, a voltage higher than a threshold level required for a 90° change in twist angle is applied to areas where scanning electrodes and signal electrodes are selected at a time, while a voltage is not applied to areas where scanning electrodes and signal electrodes are not. Linear polarizers arranged with their polarising axes perpendicular to each other arranged on the upper and lower sides of a liquid crystal, stop light from being transmitted at selected points, and allow transmission at non-selected points. Problems may however arise in the points where only one of the scanning or signal electrodes is selected. Normally, the voltage in these points should be below the threshold level and these locations should therefore allow transmission of light. The voltage may due to for example capacitive electric coupling at times exceed the threshold level and cause the liquid crystal molecules to change their twist angle thus reducing the transmission of light. This leads to lowered contrast and cross-talk.

When an electric field is no longer applied to the liquid crystal, the liquid crystal molecules return to their relaxed twist angle. This means that the writing cycle (i.e. the application of the electric field) has to be maintained as long as it is desirable to maintain the image on the liquid crystal display device. Each writing cycle also has to be kept short in order to avoid flicker and improve contrast and viewing angle. In moderate to higher resolution displays this in turn will define a bandwidth requirement increasing complexity and cost of display controllers.

The active matrix driving scheme has previous been introduced to improve performance and eliminate the need for continuous rewriting of such devices. By the introduction of semiconductor elements at every pixel position, the pixels are able to remember and maintain their last written state.

Whereas such devices, usually referred to as TFT-displays, expose excellent readability and high speed, the cost of production is high and extremely sensitive to physical display size.

U.S. Pat. No. 5,565,884 solves some of the above-mentioned problems by using a bi-stable liquid crystal in the smectic C or smectic H phase having two stable states. The liquid crystal is brought to one of the stable states by applying an electric field above a threshold level for each stable state. One of the stable states represents the selected image points, while the other represents the non-selected image points. This relieves the problems with cross talk and lowered contrast. However, these liquid crystals do not have the possibility for grey-tones and the driving method in the publication still demand complex controller electronics for the drivers, especially for large displays.

### SUMMARY OF THE INVENTION

An object of the invention is to provide a liquid crystal display device and a method for driving such a liquid crystal display device providing excellent contrast and also grey-tones using simple, low-cost controller and a minimum of drive electronics.

This object is achieved by the features stated in the patent claims.

The invention makes use of a multi-stable liquid crystal, preferably a liquid crystal in the smectic A phase. The multi-stability means that the liquid crystal substance can be brought to several different states each characterized by a ratio between transmission and reflection of light by the application of certain electric energy, and that the structure of this state is maintained without additional transfer of energy.

In the most usual configuration the maximum transmission and minimum reflection state (often referred to as the “clear” state) corresponds to black, whereas minimum transmission and maximum reflection (often referred to as the “scattered” state) corresponds to white.

To obtain grey tones, the LC structure is brought to stable states between the two extreme states corresponding to black and white by applying less electrical energy than what is needed to define the extreme state.

Building large LC display screens from a number of smaller synchronized sub-displays (image unit) is known. Because of the need for continuous refresh and the previously mentioned increasing bandwidth requirement as the number of image pixels increases, each such sub-display has traditionally been equipped with its own controller and drive electronics.

In the display according to the invention, sub-displays may share one single controller and row/column drivers in order to reduce cost. Sub-displays are mechanically and electrically put together in a way that makes the system self-organizing and hence very scalable. Providing the information frame rate is kept low (typically more than 60 seconds between complete updates for very large boards), system scalability will not be limited by bandwidth nor by power consumption.

For large display boards used for advertising, in public transportation terminals etc. the use of display boards according to the invention will lead to increased flexibility, reduced cost and power consumption.

Depending on the demands for drawing speed, the display according to the invention may be customised with respect to the number of controllers and corresponding driver units. More controllers require more driver units, but facilitate higher degree of parallel drawing of the image. In this way autonomous groups of sub-displays can be made. This ability makes the display boards very flexible in manufacture and use.

### BRIEF DESCRIPTION OF THE DRAWINGS

The invention will now be described in more detail by way of examples illustrated on the associated figure.

FIG. 1 is a schematic view of a display configuration according to the invention.

FIG. 2 shows an example of a second embodiment of the invention with capability of a higher degree of parallel processing of the image.

### DETAILED DESCRIPTION OF THE INVENTION

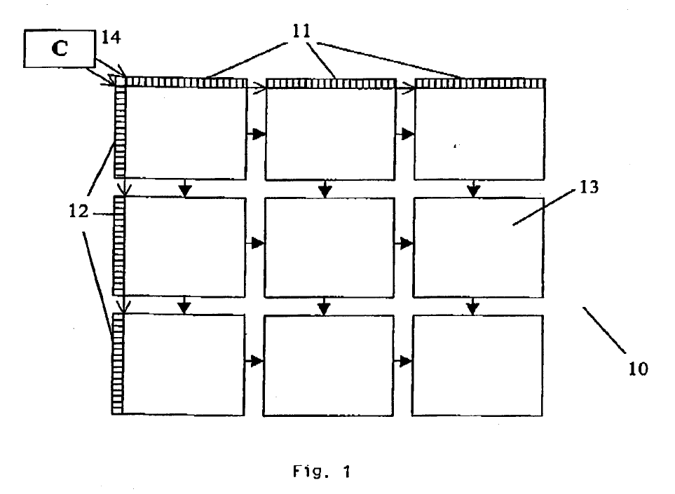

The display 10 in FIG. 1 is formed from a number of sub-displays 13. The sub-displays are of a bi- or multi-stable liquid crystal type, an example of which is shown in U.S. Pat. No. 4,139,273. In a preferred embodiment, the liquid crystal is a smectic A liquid crystal. The row driver chains 12 and column driver chains 11 are each connected in series and operated from the controller 14.

In FIG. 1 only the upper left sub-display, called the master module, is equipped with both row and column driver chains. The other upper sub-displays are equipped with column driver chains only since the line drive signals are fed from the master module. These sub-displays are called column modules. The other left sub-displays are equipped with row driver chains only since the column drive signals are fed from the master module. These sub-displays are called row modules. All other sub-displays have no driver chains and are driven by the nearest column module above and row module to the left of itself. These chain-less sub-displays are called slave modules.

A driver chain may be considered as a shift register where each bit controls a switch which feeds or brakes the row/column write signal to the corresponding row/column of the associated sub-display. Every driver chain 11 or 12 consequently has an input and an output side and connecting in series means to connect the output of the preceding chain to the input of the next chain.

At the time of writing, the controller 14 clocks in 1's and 0's into the driver chains to select the appropriate rows and columns and then it produces the row and column write signals. Those parts of a sub-display where intersecting row and column electrodes both carry the respective write signals may be changed. In the preferred embodiment the black and white write signals are separated in frequency and amplitude only.

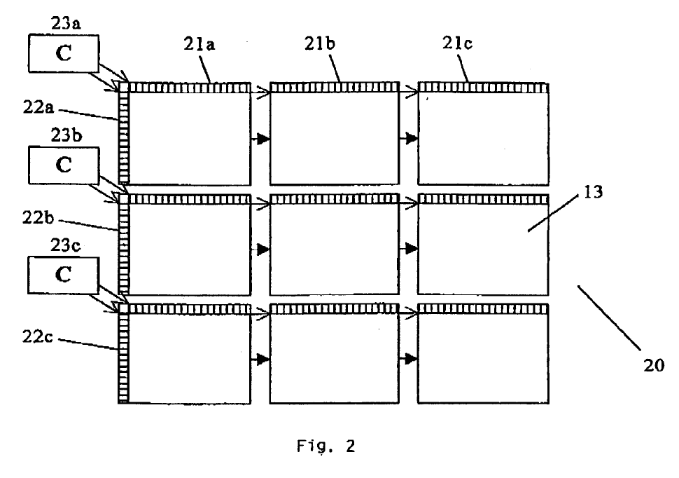

FIG. 2 shows an alternative embodiment of the present invention. The display 20 is formed from sub-displays 13 of the same kind as in FIG. 1. However, there are separate controllers 23a, 23b and 23c for each horizontal section (row) of sub-displays in order to achieve independent and possibly parallel writing in different such sections. Consequently the selection of modules is such that there are only master and column modules. Every controller must communicate directly with a master module and any module to the right of the master will be a column module which will reuse the row drive signals coming from the master and having its column drive chain serially connected to the preceding left element. Since the shown configuration has a section height of one single sub-display, row and slave modules are not applicable.

Having established the concept of a simple autonomous controller and the 4 different module types (master, row, column and slave) it is clearly possible to introduce independent display board sections with different layout types in order to maximize performance/minimize cost of production.

The embodiments illustrated are only examples, and modifications will be possible.

1. A liquid crystal display board comprising a number N of liquid crystal sub-displays arranged in i rows and j columns such that N=i×j, the liquid crystal display board comprising:
a number k of sections of sub-displays (1≦k≦N), where each section consists of m sub-displays horizontally (1≦m≦i) and n sub-displays vertically (1≦n≦j);
each section of sub-displays comprises:
a controller connected to a master module; and
a number (m−1) of column modules having a column driver chain and a number (n−1) of row modules having a row driver chain;
wherein the row and column driver chains provide a write signal to the corresponding row/column of the associated sub-display.

2. The liquid crystal display board according to claim 1, wherein the sections of sub-displays further comprise a number of ((m−1)×(n−1)) slave modules with no driver chains, and
the slave modules are configured to be driven by the nearest column module above and row module to the left of itself.

3. The liquid crystal display board according to claim 1, wherein within one section of sub-displays, all driver chains of the same type (row or column) are connected in series such that the output of a preceding chain is connected to the input of the next chain

4. The liquid crystal display board according to claim 1, wherein
the row and column driver chains comprise shift registers where each bit controls a switch which feeds or brakes the row/column write signal to the corresponding row/column of the associated sub-display

5. The liquid crystal display board according to claim 1, wherein the liquid crystal sub-displays comprises bi-stable liquid crystal material.

6. The liquid crystal display board according to claim 1, wherein the liquid crystal material comprises smectic A liquid crystal material.

7. The liquid crystal display board according to claim 1, wherein the liquid crystal sub-displays comprises multi-stable liquid crystal material.

8. A method of driving a liquid crystal display board comprising a number N of liquid crystal sub-displays arranged in i rows and j columns such that N=i×j, the method comprising:
defining a number k sections (in the area 1≦k≦N) of sub-displays, where each section consists of m sub-displays horizontally (1≦m≦i) and n sub-displays vertically (1≦n≦j);
connecting each section of sub-displays to a controller connected to a master module;
connecting the sections to a number (m−1) of column modules having a column driver chain and a number (n−1) of row modules having a row driver chain; and
wherein the row and column driver chains provide a write signal to the corresponding row/column of the associated sub-display.

9. The method of driving a liquid crystal display board according to claim 8, further including:
connecting the sections of sub-displays to a number of ((m−1)×(n−1)) slave modules with no driver chains; and
driving the slave modules by the nearest column module above and row module to the left of itself.

10. The method of driving a liquid crystal display board according to claim 8, wherein within one section of sub-displays, all driver chains of the same type (row or column) are connected in series such that the output of a preceding chain is connected to the input of the next chain.

11. The method of driving a liquid crystal display board according to claim 8, wherein the row and column driver chains function as shift registers where each bit controls a switch which feeds or brakes the row/column write signal to the corresponding row/column of the associated sub-display

12. The method of driving a liquid crystal display board according to claim 8, wherein the liquid crystal sub-displays comprise bi-stable liquid crystal material.

13. The method of driving a liquid crystal display board according to claim 12, wherein the liquid crystal material comprises smectic A liquid crystal material.

14. The method of driving a liquid crystal display board according to claim 8, wherein the liquid crystal sub-displays comprise multi-stable liquid crystal material.

15. A method of building liquid crystal display boards comprising a number N of liquid crystal sub-displays arranged in i rows and j columns such that N=i×j, the method comprising:
providing a number of k sections of sub-displays (in the area 1≦k≦N), where each section consists of m sub-displays horizontally (1≦m≦i) and n sub-displays vertically (1≦n≦j).

16. The method of building liquid crystal display boards according to claim 15, wherein
each section of sub-displays further comprises at a controller connected to a master module; and
the sections further comprises a number (m−1) of column modules having a column driver chain and a number (n−1) of row modules having a row driver chain.
